(19) United States
(12) Patent Application Publication
(10) Pub. No.: US 2014/0353992 A1
(43) Pub. Date: Dec. 4, 2014

(54) RETRIEVAL TOOL FOR RETRIEVING DROPPED ITEMS FROM AN ELEVATED LOCATION

(71) Applicant: Kevin Scott VanCamp, Reserve, LA (US)

(72) Inventor: Kevin Scott VanCamp, Reserve, LA (US)

(21) Appl. No.: 13/906,251

(22) Filed: May 30, 2013

(51) Int. Cl. B25J 1/00

(52) U.S. Cl. CPC B25J 1/00
USPC 294/82.11

(57) ABSTRACT

A non-mechanical retrieval tool retrieves dropped items silently, such as gloves, hats, or the like, from an elevated position, such as in a hunting tree stand. The retrieval tool includes an upper portion and a lower portion that and pivot relative to each other, each portion having a plurality of hooks extending therefrom. The retrieval tool is designed such that, when lowered from an elevated tree stand, it will set down in a 90 degree angle, allowing the center to pivot so that it causes the hooks to make a swooping and scooping action which, in turn, snaps the item, allowing the user to simply retrieve the item. The retrieval tool can be swung to the side and dropped through tree branches then dropped on the item without snagging the tree limbs. The retrieval tool is small, compact and silent.

### BACKGROUND OF THE INVENTION

The present invention relates to retrieval tools and, more particularly, to a retrieval tool for retrieving dropped items from an elevated location, such as a hunting tree stand.

When someone in an elevated location, such as in a hunting tree stand, drops an item, they have to come down from their elevated location to get the dropped object. This can not only take time and effort, but can also be detrimental to a hunter in a hunting tree stand. Scent control is everything when hunting, and a hunter does not want to go back to the ground and ruin the hunt. In addition, retrieving the object can also make noise, which can further cause detriment to the hunt.

While grabbers are known in the art, these grabbers are typically mechanical, noisy and, most importantly, are often big and bulky, making it a difficult addition to a hunting tree stand.

As can be seen, there is a need for a retrieval device that can be used to silently, easily and effectively retrieve items, especially when the user is in an elevated location, such as in a hunting tree stand.

### SUMMARY OF THE INVENTION

In one aspect of the present invention, a retrieval tool comprises an upper tubing member; an upper wire extending through the upper tubing member; an upper ring having the upper wire threaded therethrough; a lower tubing member pivotably attached to the upper tubing member; a lower wire disposed in the lower tubing; a lower ring disposed at a bottom end of the lower tubing member; a first set of hooks disposed about the upper tubing member; and a lower set of hooks disposed about the lower tubing member.

In another aspect of the present invention, a retrieval tool comprises an upper tubing member; an upper wire extending through the upper tubing member; an upper ring having the upper wire threaded therethrough; a lower tubing member pivotably attached to the upper tubing member; a lower wire disposed in the lower tubing; a lower ring disposed at a bottom end of the lower tubing member; a first set of hooks disposed about the upper tubing member proximate an upper tubing member bottom side thereof; a lower set of hooks disposed about the lower tubing member proximate a lower tubing member bottom side thereof; and shrink tubing for securing the first set of hooks to the upper tubing member and the lower set of hooks to the lower tubing member.

These and other features, aspects and advantages of the present invention will become better understood with reference to the following drawings, description and claims.

### BRIEF DESCRIPTION OF THE DRAWINGS

FIG. 1 is a perspective view of a retrieval device according to an exemplary embodiment of the present invention;

FIG. 2 is a cross-sectional view taken along line 2-2 of FIG. 1;

FIG. 3 is a perspective view of the retrieval device of FIG. 1, in use to retrieve an object, such as a glove.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a non-mechanical retrieval tool for retrieving dropped items silently, such as gloves, hats, or the like, from an elevated position, such as in a hunting tree stand. The retrieval tool includes an upper portion and a lower portion that and pivot relative to each other, each portion having a plurality of hooks extending therefrom. The retrieval tool is designed such that, when lowered from an elevated tree stand, it will set down in a 90 degree angle, allowing the center to pivot so that it causes the hooks to make a swooping and scooping action which, in turn, snaps the item, allowing the user to simply retrieve the item. The retrieval tool can be swung to the side and dropped through tree branches then dropped on the item without snagging the tree limbs. The retrieval tool is small, compact and silent.

The retrieval tool of the present invention solves the problem of having to come back down a tree from a hunting tree stand because an item has been dropped. Without the retrieval tool, a hunter is left using a bulky, mechanical, and noisy grabber, or must descend the tree, risking being seen or spreading an undesirable scent.

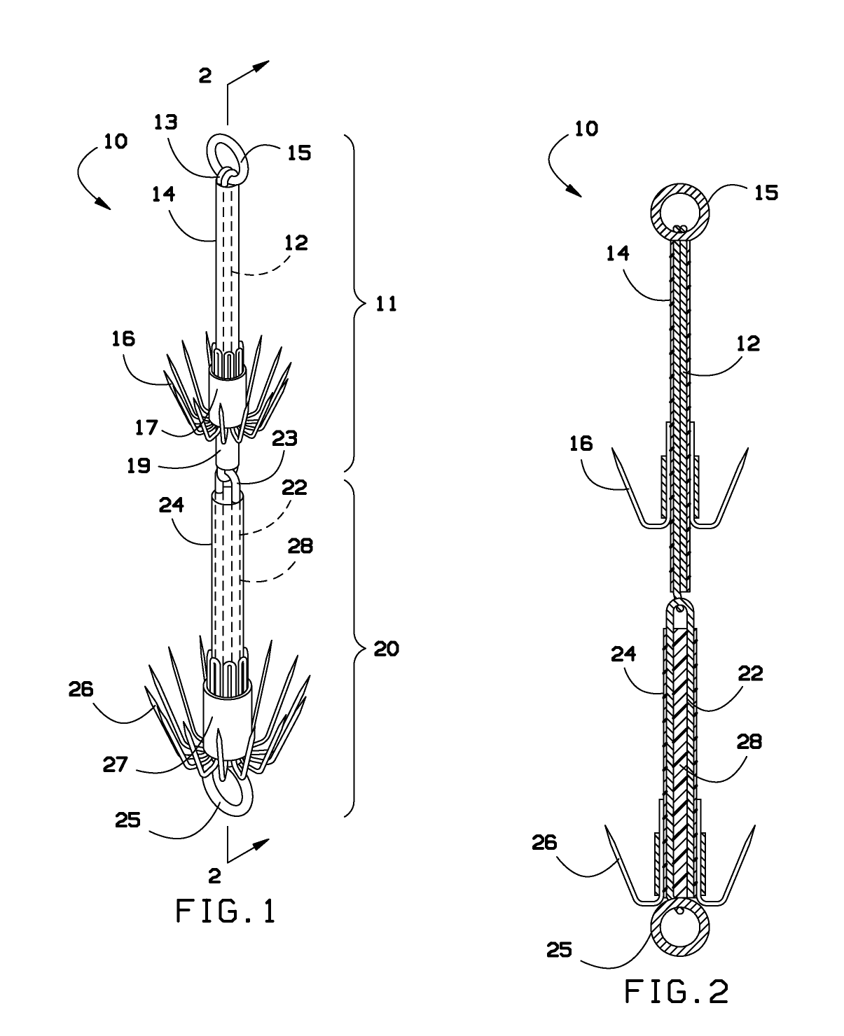

Referring now to FIGS. 1 through 3, a retrieval tool 10 can includes an upper section 11 and a lower section 20 connected to permit pivoting therebetween. The upper section 11 can include an upper ring 15 having an upper wire 12 extended in an upper loop 13 about the upper ring 15. The upper wire 12 can include a section of tubing 14 into which the wire extends and out of which the upper loop 13 extends. The upper wire 12 can have a lower loop 19 extending from a lower end of the tubing 14. In some embodiments, the tubing 14 can be a general purpose polyfin heat shrink tubing, having a diameter of about 5/16 inch and a length of about 1 ⅞ inch.

A set of hooks 16 can be disposed about the tubing 14, near a bottom end thereof. In some embodiments, the set of hooks 16 can be a 14 mm, 15-prong stainless, barbless hook that is slid over the tubing 14. A heat shrink tubing 17 can be applied to secure the set of hooks 16 to the tubing 14.

Similarly, the lower portion 20 can include a lower wire 22 encased in a lower tubing 24 having an upper loop 23 attached to the lower loop 19 of the upper wire 12. A lower set of hooks 26 can be disposed below a mid point of the tubing 24, typically adjacent a lower end of the lower tubing 24. A heat shrink tubing 27 can be used to secure the lower set of hooks 26 onto the tubing 24. A lower ring 25 can be attached to a bottom side of the lower tubing 24. In some embodiments, a filler material 28 can be disposed in the lower tubing 24 to adjust the diameter of the lower tubing 24.

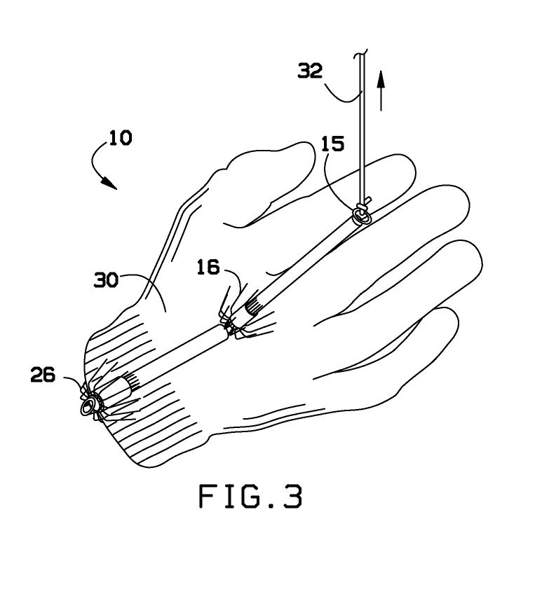

Referring to FIG. 3, to use the retrieval tool 10 of the present invention, a string 32 can be tied to the upper ring 15 and the retrieval tool 10 can be lowered toward an object to be retrieved, such as a glove 30. Once the sets of hooks 16, 26 catches the glove 30, the user can simply raise the string 32 to raise the glove 30 up to they, thereby quickly, easily and silently retrieving the dropped item.

The retrieval tool 10 can be used to retrieve just about any dropped, unreachable item in various locations and situations. For example, the retrieval tool 10 can be used to retrieve dropped items around the house, off a ladder, out of bucket trucks, or the like. The retrieval tool 10 can be used to retrieve ducks and decoys, get keys that were dropped into storm drains, for picking up dead chickens, or the like.

It should be understood, of course, that the foregoing relates to exemplary embodiments of the invention and that modifications may be made without departing from the spirit and scope of the invention as set forth in the following claims.

What is claimed is:

1. A retrieval tool comprising:
an upper tubing member;
an upper wire extending through the upper tubing member;
an upper ring having the upper wire threaded therethrough;
a lower tubing member pivotably attached to the upper tubing member;
a lower wire disposed in the lower tubing;
a lower ring disposed at a bottom end of the lower tubing member;
a first set of hooks disposed about the upper tubing member; and
a lower set of hooks disposed about the lower tubing member.

2. The retrieval tool of claim 1, wherein the first set of hooks and the second set of hooks are disposed proximate to bottom sides of the upper tubing member and the lower tubing member, respectively.

3. The retrieval tool of claim 1, wherein the first set of hooks and the second set of hooks include a plurality of hooks spaced apart about a perimeter of the upper tubing member and the lower tubing member, respectively.

4. The retrieval tool of claim 1, wherein the first set of hooks and the second set of hooks are barbless hooks.

5. The retrieval tool of claim 1, further comprising shrink tubing for securing the first set of hooks to the upper tubing member and the lower set of hooks to the lower tubing member.

6. The retrieval tool of claim 1, wherein the lower wire forms a loop, extending from the lower tubing member, that intertwines into a lower loop of the upper wire, extending from the upper tubing member.

7. The retrieval tool of claim 1, further comprising a string attached to the upper ring.

8. A retrieval tool comprising:
an upper tubing member;
an upper wire extending through the upper tubing member;
an upper ring having the upper wire threaded therethrough;
a lower tubing member pivotably attached to the upper tubing member;
a lower wire disposed in the lower tubing;
a lower ring disposed at a bottom end of the lower tubing member;
a first set of hooks disposed about the upper tubing member proximate an upper tubing member bottom side thereof;
a lower set of hooks disposed about the lower tubing member proximate a lower tubing member bottom side thereof; and
shrink tubing for securing the first set of hooks to the upper tubing member and the lower set of hooks to the lower tubing member.

9. The retrieval tool of claim 8, wherein the lower wire forms a loop, extending from the lower tubing member, that intertwines into a lower loop of the upper wire, extending from the upper tubing member.

10. The retrieval tool of claim 8, further comprising a string attached to the upper ring.
